(19) United States
(12) Patent Application Publication
(10) Pub. No.: US 2024/0244593 A1
(43) Pub. Date: Jul. 18, 2024

(54) USER EQUIPMENT AND BASE STATION FOR AVAILABILITY INDICATION SIGNALING OF TRS/CSI-RS OCCASION TO IDLE/INACTIVE UESER EQUIPMENT

(71) Applicant: Huizhou TCL Cloud Internet Corporation Technology Co., Ltd., Huizhou, Guangdong (CN)

(72) Inventors: Shahid JAN, Huizhou, Guangdong (CN); Jia SHENG, Huizhou, Guangdong (CN)

(73) Assignee: Huizhou TCL Cloud Internet Corporation Technology Co., Ltd., Huizhou, Guangdong (CN)

(21) Appl. No.: 18/574,153

(22) PCT Filed: Jul. 6, 2021
(86) PCT No.: PCT/CN2021/104794

§ 371 Date: Dec. 26, 2023

(51) Int. Cl. H04W 72/04; H04W 68/02

(52) U.S. Cl. CPC H04W 72/04; H04W 68/02

(57) ABSTRACT

Disclosed are a user equipment (UE) and a base station (B) for availability indication of Tracking Reference Signal (TRS)/Channel State Information Reference Signal (CSI-RS) occasion to idle/inactive UE. The UE receives an indication of availability of TRS/CSI-RS occasion in an idle/inactive state from the BS through System Information Block (SIB) based signaling in at least one of the following: (a) whenever the UE does not have a valid version of a stored SIB which is used to configure TRS/CSI-RS resource; (b) upon cell selection or cell-reselection performed by the UE; and (c) when the UE returns from out of coverage. Similarly, a UE receives an indication of availability of TRS/CSI-RS occasion in an idle/inactive state from the BS through Layer 1 (L1) based signaling in at least one of the following: (a) whenever the UE is camped on a same serving cell for at least two paging occasions (POs); and (b) upon receiving an indication that system information has changed but the UE still remains camped on the same serving cell. This can solve issues in the prior art, and allow BS the flexibility of selecting an appropriate signaling type according to a specific occasion.

### TECHNICAL FIELD

The present disclosure relates to wireless communication, and more particularly, to a user equipment (UE) and a base station (BS) for availability indication signaling of Tracking Reference Signal (TRS)/Channel State Information Reference Signal (CSI-RS) occasion to idle/inactive UE.

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN includes a set of base stations (BSs) which provide wireless links to the UEs located in cells covered by the base station, and an interface to a core network (CN) which provides overall network control. The RAN and CN each conducts respective functions in relation to the overall network.

The 3rd Generation Partnership Project has developed the so-called Long-Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a next generation Node B called gNodeB (gNB).

The 5G standard will support a multitude of different services each with very different requirements. These services include Enhanced Mobile Broadband (eMBB) for high data rate transmission, Ultra-Reliable Low Latency Communication (URLLC) for devices requiring low latency and high link reliability and Massive Machine-Type Communication (mMTC) to support a large number of low-power devices for a long life-time requiring highly energy efficient communication.

Energy efficiency is one of the key player in 5G NR to support diversified use cases including the eMBB, mMTC and URLLC. To conserve energy and enhance the UE battery life time, numerous power saving techniques has been defined and implemented in 5G NR. Discontinuous Reception (DRx) is one of the effective power saving technique defined in 5G NR, in which a UE goes into Radio Resource Control (RRC)-IDLE/INACTIVE mode, turn off the Radio Frequency (RF) and periodically wake up to monitor Physical Downlink Control Channel (PDCCH) for checking the presence of paging messages. A UE in RRC-IDLE/INACTIVE mode consumes power for various activities such as Automatic Gain Control (AGC) and time/frequency (T/F) channel tracking, Radio Resource measurement (RRM) and paging monitoring. For this purpose, LTE supports always-on Cell Specific Reference Signal (CRS) in every sub frame as illustrated in FIG. 1. On the other hand, NR supports Synchronization Signal Block (SSB) and usually needs several SSB burst which is transmitted with longer periodicity (e.g., 20 ms) compared to LTE CRS thus leading UE to consume more power than LTE as shown in FIG. 2.

In NR a UE in IDLE/INACTIVE mode, needs to wake-up much earlier, much longer, and more frequently compared to LTE UE for the subsequent activities e.g., AGC and T/F tracking. Accordingly, the power consumption of NR UE in IDLE/INACTIVE mode is much higher than the power consumption of LTE UE in IDLE mode. Based on this motivation, 3GPP RAN WG has agreed to specify potential Tracking Reference Signal (TRS)/Channel State Information Reference Signal (CSI-RS) occasion(s) for IDLE/INACTIVE mode UE in order to replace the legacy SSB based synchronization before a paging occasion (PO) and enhance power saving as shown in FIG. 3.

In addition, RAN WG approved work item in WID for Rel-17 UE power saving enhancements in idle/inactive mode UE, considering system performance aspects including specifying means to provide potential TRS/CSI-RS occasion(s) available in connected mode to idle/inactive-mode UEs, minimizing system overhead impact, and it was noted that always-on TRS/CSI-RS transmission by gNodeB is not required.

In 3GPP RAN1 #104-e meeting it was agreed that “The availability of TRS/CSI-RS at the configured occasion(s) is informed to the UE”. Since the availability of TRS/CSI-RS depends on connected UEs in the network, therefore in the presence of TRS/CSI-RS in the network, idle/inactive UE shall be informed early to avoid its blind detection complexity for TRS/CSI-RS decoding. Furthermore, in 3GPP RAN1 #105-e meeting it has been discussed and agreed to support both System Information Block (SIB) based signaling and Layer 1 (L1) based signaling (such as Paging Early Indication (PEI) and paging Downlink Control Information (DCI)) for the availability indication of TRS/CSI-RS at the configured occasion(s) to the idle/inactive UEs.

However, the availability indication of TRS/CSI-RS occasion(s) to the idle/inactive UEs needs to be further developed in many aspects and needs further improvements.

### Technical Problem

The objective of the present disclosure is to provide a user equipment (UE) and a base station (BS) for improving availability indication of TRS/CSI-RS occasion(s) to the idle/inactive UEs. For this purpose, the present disclosure considers multiple options to simultaneously configure both SIB based signaling and L1 based signaling and allow BS to enable/disable one signaling at a time.

### Technical Solution

A first aspect of the present disclosure provides a user equipment (UE), comprising a processor, configured to call and run program instructions stored in a memory, to execute:
receiving an indication of availability of Tracking Reference Signal (TRS)/Channel State Information Reference Signal (CSI-RS) occasion in an idle/inactive state from a base station (BS) through System Information Block (SIB) based signaling in at least one of the following:
(a) whenever the UE does not have a valid version of a stored SIB which is used to configure TRS/CSI-RS resource;
(b) upon cell selection or cell-reselection performed by the UE; and
(c) when the UE returns from out of coverage.

A second aspect of the present disclosure provides a user equipment (UE), comprising a processor, configured to call and run program instructions stored in a memory, to execute:
receiving an indication of availability of Tracking Reference Signal (TRS)/Channel State Information Reference Signal (CSI-RS) occasion in an idle/inactive state from a base station (BS) through Layer 1 (L1) based signaling in at least one of the following:
(a) whenever the UE is camped on a same serving cell for at least two paging occasions (POs); and
(b) upon receiving an indication that system information has changed but the UE still remains camped on the same serving cell.

A third aspect of the present disclosure provides a user equipment (UE), comprising a processor, configured to call and run program instructions stored in a memory, to execute:
being configured by a base station (BS) by simultaneous configuration of both System Information Block (SIB) based signaling and Layer 1 (L1) based signaling for availability indication of Tracking Reference Signal (TRS)/Channel State Information Reference Signal (CSI-RS) occasion in an idle/inactive state.

A fourth aspect of the present disclosure provides a user equipment (UE), comprising a processor, configured to call and run program instructions stored in a memory, to execute:
being configured with one of either System Information Block (SIB) based signaling or Layer 1 (L1) based signaling considered as default signaling for availability indication of Tracking Reference Signal (TRS)/Channel State Information Reference Signal (CSI-RS) occasion in an idle/inactive state, and being configured to enable/disable the other one either the SIB based signaling or the L1 based signaling, wherein when one type of TRS/CSI-RS availability indication signaling is enabled, the other type of TRS/CSI-RS availability indication signaling is considered as disable; or when one type of TRS/CSI-RS availability indication signaling is disabled, the other type of TRS/CSI-RS availability indication signaling is considered as enable.

A fifth aspect of the present disclosure provides a user equipment (UE), comprising a processor, configured to call and run program instructions stored in a memory, to execute:
being configured to enable one of System Information Block (SIB) based signaling and Layer 1 (L1) based signaling for availability indication of Tracking Reference Signal (TRS)/Channel State Information Reference Signal (CSI-RS) occasion in an idle/inactive state, by using configuration information comprising a field configured in a same SIB_X which is used to configure TRS/CSI-RS resource, where X is an integer selected from 2 to 13,
wherein the SIB based signaling is considered as disable when the L1 based signaling is enabled, and the L1 based signaling is considered as disable when the SIB based signaling is enabled.

A sixth aspect of the present disclosure provides a base station (BS), comprising a processor, configured to call and run program instructions stored in a memory, to execute:
transmitting to a user equipment (UE) an indication of availability of Tracking Reference Signal (TRS)/Channel State Information Reference Signal (CSI-RS) occasion in an idle/inactive state of the UE through System Information Block (SIB) based signaling in at least one of the following:
(a) whenever the UE does not have a valid version of a stored SIB which is used to configure TRS/CSI-RS resource;
(b) upon cell selection or cell-reselection performed by the UE; and
(c) when the UE returns from out of coverage.

A seventh aspect of the present disclosure provides a base station (BS), comprising a processor, configured to call and run program instructions stored in a memory, to execute:
transmitting to a user equipment (UE) an indication of availability of Tracking Reference Signal (TRS)/Channel State Information Reference Signal (CSI-RS) occasion in an idle/inactive state of the UE through Layer 1 (L1) based signaling in at least one of the following:
(a) whenever the UE is camped on a same serving cell for at least two paging occasions (POs); and
(b) upon receiving an indication that system information has changed but the UE still remains camped on the same serving cell.

An eighth aspect of the present disclosure provides a base station (BS), comprising a processor, configured to call and run program instructions stored in a memory, to execute:
configuring a user equipment (UE) by simultaneous configuration of both System Information Block (SIB) based signaling and Layer 1 (L1) based signaling for availability indication of Tracking Reference Signal (TRS)/Channel State Information Reference Signal (CSI-RS) occasion in an idle/inactive state of the UE.

A ninth aspect of the present disclosure provides a base station (BS), comprising a processor, configured to call and run program instructions stored in a memory, to execute:
configuring a user equipment (UE) with one of either System Information Block (SIB) based signaling or Layer 1 (L1) based signaling is considered as default signaling for availability indication of Tracking Reference Signal (TRS)/Channel State Information Reference Signal (CSI-RS) occasion in an idle/inactive state of the UE, and configuring the UE to enable/disable the other one either the SIB based signaling or the L1 based signaling, wherein when one type of TRS/CSI-RS availability indication signaling is enabled, the other type of TRS/CSI-RS availability indication signaling is considered as disable; or when one type of TRS/CSI-RS availability indication signaling is disabled, the other type of TRS/CSI-RS availability indication signaling is considered as enable.

A tenth aspect of the present disclosure provides a base station (BS), comprising a processor, configured to call and run program instructions stored in a memory, to execute:
configuring a user equipment (UE) to enable one of System Information Block (SIB) based signaling and Layer 1 (L1) based signaling for availability indication of Tracking Reference Signal (TRS)/Channel State Information Reference Signal (CSI-RS) occasion in an idle/inactive state of the UE, by using configuration information comprising a field configured in a same SIB_X which is used to configure TRS/CSI-RS resource, where X is an integer selected from 2 to 13,
wherein the SIB based signaling is considered as disable when the L1 based signaling is enabled, and the L1 based signaling is considered as disable when the SIB based signaling is enabled.

### Advantageous Effects

This disclosure benefits by any of the following. Use cases are defined to cover all scenarios which are appropriate for either SIB based signaling or L1 based signaling. Network/gNB is enriched with a toolbox of TRS/CSI-RS availability indication signaling by simultaneous configuration of both SIB/L1 based signaling and network/gNB is allowed to have the flexibility of selecting an appropriate signaling type for a specific use case scenario. Enabling/disabling of SIB based signaling and L1 based signaling are considered, in order to use only one appropriate signaling type at a time. UE is allowed to use a signaling type according to a specific use case in order to enhance power saving. TRS/CSI-RS availability indication is considered based on per cell and per group in order to reduce the availability indication overhead.

### DESCRIPTION OF DRAWINGS

In order to more clearly illustrate the embodiments of the present disclosure or related art, the following figures that will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating LTE IDLE UE Synchronization from a serving cell in existing arts.

FIG. 2 is a schematic diagram illustrating NR IDLE/INACTIVE mode UE Synchronization using SSB from a serving cell in existing arts.

FIG. 3 is a schematic diagram illustrating NR IDLE/INACTIVE mode UE Synchronization using TRS/CSI-RS from a serving cell in existing arts.

FIG. 4 is a schematic diagram illustrating PEI based availability indication of TRS according to the present disclosure.

FIG. 5 is a schematic diagram illustrating P-DCI based availability indication of TRS according to the present disclosure.

FIG. 6 is a schematic diagram illustrating Non-Consecutive Paging of UE in successive PO of a PF according to the present disclosure.

FIG. 7 is a schematic diagram illustrating Consecutive Paging of UE in successive PO of a PF according to the present disclosure.

FIG. 8 is a block diagram of an example system for wireless communication according to an embodiment of the present disclosure.

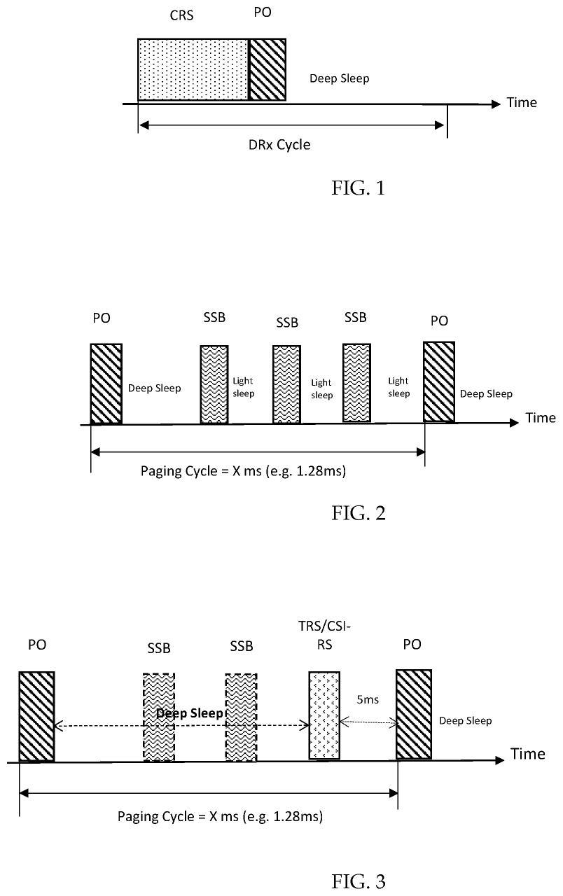

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The following table includes some abbreviations, which may be used in some embodiments of the present disclosure:

| Abbreviation | Full name |
|---|---|
| UE | user equipment |
| BS | base station |
| TRS | Tracking Reference Signal |
| CSI-RS | Channel State Information Reference Signal |
| SIB | System Information Block |
| L1 | Layer 1 |
| PO | paging occasion |
| PEI | Paging Early Indication |
| DCI | Downlink Control Information |
| P-DCI | paging Downlink Control Information |
| DRx | Discontinuous Reception |
| RRC | Radio Resource Control |
| AGC | Automatic Gain Control |
| T/F | time/frequency |
| RRM | Radio Resource measurement |
| CRS | Cell Specific Reference Signal |
| SSB | Synchronization Signal Block |

It has been discussed and agreed to support both SIB based signaling and L1 based signaling, where L1 based signaling can be PEI based Indication or Paging-DCI based Indication, to inform the availability of TRS/CSI-RS at the configured occasion(s) to the idle/inactive UE prior the paging occasion (PO). However, the detail design of simultaneous configuration of SIB based signaling and L1 based signaling for availability indication of TRS/CSI-RS occasion to the idle/inactive UE is still under discussion and there is no concreate proposal in this regard. Furthermore, how to enable/disable SIB/L1 based signaling and which signaling type is useful in power saving according to a specific scenario is still not clear. Therefore, some embodiments of the present disclosure consider the use case scenarios of SIB/L1 based signaling and propose several options of simultaneous configuration of both SIB based singaling and L1 based singaling for TRS/CSI-RS availability indication to the idle/inactive UE. Furthermore, some embodiments of the present disclosure also study and propose several options of how to enable/disable SIB based signaling and L1 based signaling, in order to use only one singling type which is useful in power saving according to a specific use case scenario.

The goal of simultaneous configuration of both SIB based signaling and L1 based signaling for availability indication of TRS/CSI-RS occasions to the idle/inactive UE is to enrich the network/gNB with a toolbox of all possible types of TRS/CSI-RS availability indication signaling and allow network/gNB to select the best TRS/CSI-RS availability indication signaling which is useful for power saving according to a specific use case scenario. However, regarding simultaneous configuration and whether to use SIB based signaling or L1 based signaling for TRS/CSI-RS availability indication, the present disclosure discusses several issues as given below.
How to configure both SIB based signaling and L1 based signaling simultaneously for availability indication of TRS/CSI-RS occasion to the idle/inactive UEs.
Which signaling type (either SIB based or L1 based) is useful for which specific scenario.
How to enable/disable SIB based signaling and L1 based signaling in order to use only one signaling at a time and increase power saving gain.
Whether to indicate the availability in per group based or per cell based.

In order to simultaneously configure both SIB based signaling and L1 based signaling for availability indication of TRS/CSI-RS to the idle/inactive UE and efficiently use only one signaling type according to a suitable use case scenario, the present disclosure proposes several options of both simultaneous configuration and enabling/disabling of SIB based and L1 based signaling.

### 1 Signaling Method and its Usage According to Specific Use Case Scenarios

This embodiment of the present disclosure explains, SIB based signaling and L1 based signaling and its application according to the specific use case scenario. It shall be noted that the network/gNB can uses only one signaling type at a time to inform the availability indication of TRS/CSI-RS occasion(s) to the idle/inactive UE prior the PO.

### 1.1 SIB Based Signaling for Availability Indication of TRS/CSI-RS

In an embodiment of the present disclosure, SIB based signaling is considered to inform early the availability of TRS/CSI-RS occasions to an idle/inactive UE and avoid its blind detection complexity for decoding of TRS/CSI-RS. The availability indication through SIB based signaling can be performed by the following two techniques.

A) The availability indication of TRS/CSI-RS occasion to the idle/inactive UE is associated to the presence or absence of the same SIB_X which is used to configure the TRS/CSI-RS resource to the idle/inactive UE, where X is an integer {X=2, 3, . . . 13}. For instance, a TRS/CSI-RS resource_1 is configured through SIB_X, thus in the presence of the same SIB_X a UE will assume that TRS/CSI-RS resource_1 is available and in the absence of the same SIB_X a UE will assume that the TRS/CSI-RS resource_1 is not available.

B) The SIB_X can carry a bit which can be used to inform the availability of TRS/CSI-RS to the idle/inactive UE. For instance, SIB_X is used to configure a TRS/CSI-RS resource to the idle/inactive UE. The same SIB_X is carrying a bit in the form of bitmap or codepoint which is used to inform the availability of the same TRS/CSI-RS resource to idle/inactive UEs which is configured through same SIB_X.

In an embodiment of the present disclosure, A network/gNB shall configure and a UE shall expect SIB based signaling for availability indication of TRS/CSI-RS occasion in the following use cases:
whenever a UE does not have a valid version of a stored SIB-X which is used for TRS/CSI-RS configuration
Upon the UE cell selection (e.g., upon power on) or cell-reselection
When a UE returns from out of coverage

### 1.2 L1 Based Signaling for Availability Indication of TRS/CSI-RS

In an embodiment of the present disclosure, L1 based signaling such as PEI or legacy paging DCI can carry the availability indication of TRS/CSI-RS in the form of bitmap or codepoints.

Wherein, a network/gNB shall configure and a UE shall expect L1 based signaling for availability indication of TRS/CSI-RS occasion in the following cases:
Whenever a UE is camped on the same serving cell for at-least two PO.
Upon receiving an indication that the system information has changed but the UE still remains camped on the same serving cell.

However, only one L1 signaling type either PEI or paging DCI shall be used to carry the availability indication of TRS/CSI-RS resources. Using PEI or paging DCI (P-DCI) based availability indication of TRS/CSI-RS occasion depends on the non-consecutive and consecutive paging of a UE in successive paging occasion (PO) of a paging frame respectively.

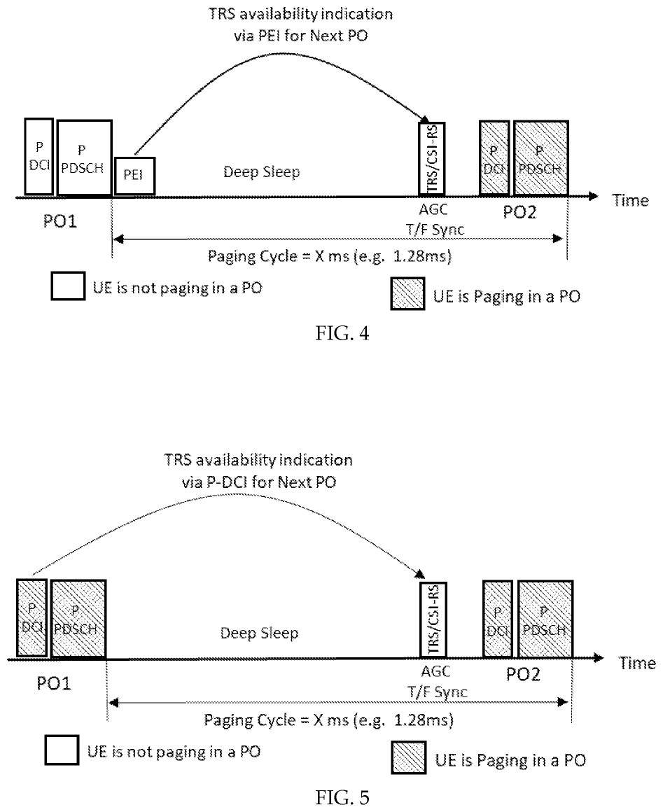

In an embodiment of the present disclosure, PEI can be used to carry the availability indication of TRS/CSI-RS occasion, when UE is paging in non-consecutive way in successive PO of a paging frame as shown in FIG. 4. For instance, as shown in FIG. 4, a UE is not being paged in PO1 and it needs paging in PO2, thus gNB can use PEI to inform the availability indication of TRS/CSI-RS occasion. In this case, using P-DCI of the PO1 to inform the TRS/CSI-RS availability indication for PO2 will unnecessarily wake up the UE in PO1 and waste its power.

Similarly, P-DCI can be used to carry the availability indication of TRS/CSI-RS occasion, when a UE is paging in consecutive way in successive PO of a paging frame as shown in FIG. 5. For instance, as shown in FIG. 5, a UE is paging in PO1 and PO2 in consecutive way, thus a gNB can use P-DCI of PO1 to inform the availability indication of TRS/CSI-RS occasion for the next PO which is PO2. In this case, using P-DCI based availability indication of TRS/CSI-RS occasion is more beneficial in power saving perspective than the PEI based indication.

In other words, using L1 based signaling for TRS availability a UE is expecting P-DCI based TRS/CSI-RS availability indication only when a UE is paging for at least two PO consecutively, otherwise a UE is expecting PEI based TRS/CSI-RS availability indication.

### 2 Simultaneous Configuration of SIB Based and L1 Based Signaling for TRS/CSI-RS Occasion

In some embodiments of the present disclosure, Simultaneous configuration of SIB based signaling and L1 based signaling for availability indication of TRS/CSI-RS occasion will allow network/gNB to flexibly select the best availability indication signaling which is appropriate for a specific use case scenario. For simultaneous configuration of SIB based signaling and L1 based signaling for availability indication of TRS/CSI-RS occasion to the idle/inactive UE this disclosure proposes the following options.

### 2.1 Simultaneous Configuration Through SIB_X

In an embodiment of the present disclosure, it is proposed to configure both SIB based signaling and L1 based signaling using the same SIB_X which is used for a TRS/CSI-RS configuration, where X={2, 3, 4, . . . , 13}. For instance, the configuration of SIB based signaling and L1 based signaling for availability indication of TRS/CSI-RS resource_1 to the idle/inactive UE can be included in the same SIB_X which is used to configure the TRS/CSI-RS resource_1. The information element (IE) for this simultaneous configuration is given below.

SIB_X information element

| .... | | |
|---|---|---|
| SIB-Indication | ENUMERATED {supported} | OPTIONAL |
| L1-Indication | ENUMERATED {supported} | OPTIONAL |

### 2.2 Simultaneous Configuration Through Pre-Configuration

In some embodiments of the present disclosure, it is proposed to configure both SIB based signaling and L1 based signaling for availability indication of TRS/CSI-RS occasion to the idle/inactive UE through pre-configuration in the design of UE. Since in this embodiment, the configuration of both SIB based signaling and L1 based signaling is already included in the design of UE, thus gNB do not need to configure an availability indication signaling to the idle/inactive UE which leads the network/gNB to reduce its signaling overhead.

In this case, a gNB only have to enable an availability indication signaling type at a time which is appropriate according to a specific use case scenario and disable the other availability indication signaling type. The IE of simultaneous configuration through pre-configuration can be performed by the proposed IE TRS-AvailabilityIndication Config.

### TRS-AvailabilityIndication Config

In an embodiment of the present disclosure, The IE TRS-AvailablityIndicationConfig specifies the simultaneous configuration information for TRS/CSI-RS availability indication signaling through pre-configuration.

TRS-AvailabilityIndicationConfig information element

| -- ASN1START | |
|---|---|
| -- TAG-TRS-AvailiablityIndicationConfig-START | |
| TRS-AvailabilityIndicationConfig ::= | SEQUENCE { |

| | |
|---|---|
| | CHOICE { |
| SIB-Indication | ENUMERATED {supported} |
| L1-Inidcation | ENUMERATED {typeA, typeB} |

| } | |
|---|---|
| } | |
| L1-Indication-IE | ::= SEQUENCE { |

| | |
|---|---|
| | CHOICE { |
| PEI-Indication | ENUMERATED {supported} |
| PDCI-Indication | ENUMERATED {supported} |

}
-- TAG-TRS-AvailabilityIndicationConfig-STOP
-- ASN1STOP

The description of TRS-AvailabilityIndicationConfig is explained in the following table 1.

TABLE 1

| Conditional Presence | Explanation |
|---|---|
| SIB-Indication | This field configures SIB based signaling and it mandatory presents in case |
| | of SIB based indication via pre-configuration; otherwise, the field is |
| | Optionally present. |
| L1-Indication | This field configures L1 based signaling and it is mandatory presents in |
| | case of L1based indication via pre-configuration; otherwise, the field is |
| | Optionally present. |
| PEI | This field is optionally present in case of L1 based indication through pre- |
| | configuration. |
| P-DCI | This field is optionally present in case of L1 based indication through pre- |
| | configuration. |

### 2.3 Through Pre-Configuration and SIB_X

In some embodiments of the present disclosure, the following two options are proposed to configure both SIB based signaling and L1 based signaling using both pre-configuration in the design of UE, and SIB_X by gNB.

a) In option 1, L1 based signaling for availability indication of TRS/CSI-RS to the idle/inactive UE is pre-configured in the design of UE through pre-configuration e.g., TRS-AvailabilityIndicationConfig, and SIB based signaling for availability indication of TRS/CSI-RS to the idle/inactive UE is configured by gNB through the same SIB_X which is used to configure the TRS/CSI-RS resources.

b) In option 2, SIB based signaling for availability indication of TRS/CSI-RS to the idle/inactive UE is pre-configured in the design of UE through pre-configuration e.g., TRS-AvailabilityIndicationConfig, and L1 based signaling for availability indication of TRS/CSI-RS to the idle/inactive UE is configured by gNB through the same SIB_X which is used to configure the TRS/CSI-RS resources.

### 3 Enabling/Disabling of SIB Based and L1 Based Signaling

In this embodiment of the present disclosure, it is explained and proposed three possible options of how to enable/disable SIB based signaling and L1 based signaling of TRS/CSI-RS availability indication according to different use case scenario as explained in section 1. It is a matter of common understanding that only one type of signaling can be used at a single time according to a specific use case scenario.

### 1) Option 1: SIB Based Signaling is Considered as Default Signaling and L1 Based Signaling is Enabled/Disabled

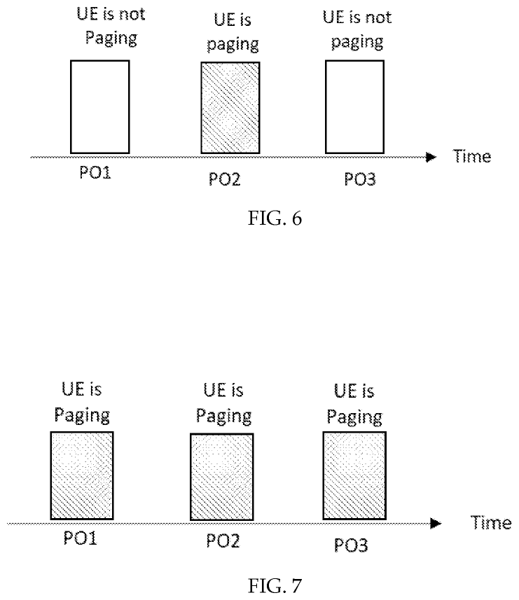

In an embodiment of the present disclosure, SIB based signaling is considered as default signaling for availability indication of TRS/CSI-RS occasion to the idle/inactive UE and L1 based signaling can be enable/disable according to a specific use case scenario. To enable L1 based signaling, gNB can use a trigger event. Here a trigger event is the time for which a UE is camped on the same serving cell for at least two POs. Furthermore, when the L1 based signaling is enabled, whether to use PEI based indication or P-DCI based indication depends on the consecutive and non-consecutive paging of a UE in successive POs of a paging frame. For instance, when UE is paging in non-consecutive way in successive PO of a paging frame as shown in FIG. 6, PEI based indication shall be considered. When UE is paging in consecutive way in successive PO of a paging frame as shown in FIG. 7, then P-DCI based indication shall be considered. It is worthy note that when one type of TRS/CSI-RS availability indication signaling is enabled, the other type of availability indication signaling will be considered as disable. The validity of L1 based signaling in this case is the time until the UE is camped on the same serving cell. When UE move to a new cell, the L1 signaling of TRS/CSI-RS availability indication received from the original cell becomes invalid. Thus, the default signaling, which is SIB based signaling, becomes enable to inform the availability indication of TRS/CSI-RS occasion to the idle/inactive UE.

### 2) Option 2: L1 Based Signaling is Considered as Default Signaling and SIB Based Signaling is Enabled/Disabled

In some embodiments of the present disclosure, L1 based signaling is considered as default signaling for availability indication of TRS/CSI-RS occasion to the idle/inactive UE and SIB based signaling can be enable/disable according to a specific use case scenario as explained in section 1. Furthermore, when L1 based signaling is considered as TRS/CSI-RS availability indication signaling, whether to use PEI based indication or P-DCI based indication depends on the consecutive and non-consecutive paging of a UE in successive PO of a paging frame. For instance, when UE is paging in non-consecutive way in successive PO of a paging frame as shown in FIG. 6, PEI based indication shall be considered. When UE is paging in consecutive way in successive PO of a paging frame as shown in FIG. 7, then P-DCI based indication shall be considered.

To enable SIB based signaling, gNB can use a trigger event. Here a trigger event is the moving of UE to new cell and perform cell reselection or returning of a UE from out of coverage. For instance, when UE move to new cell and perform cell reselection or when the UE return from out of coverage, the L1 signaling of TRS availability received from the original cell becomes invalid and the UE cannot assume the availability of TRS/CSI-RS using the L1 signaling. Thus, the gNB will enable SIB based signaling. It is worthy to note that when one type of signaling is enabled the other type of signaling will be considered as disable. The validity of SIB based signaling in this case is until the next PO. After the next PO the SIB based signaling will be invalid and the default signaling, which is L1 based signaling, becomes enable to inform the availability indication of TRS/CSI-RS occasion to the idle/inactive UE.

Since most of the time a UE is camped on the same serving cell therefore considering L1 based signaling as default signaling for TRS availability is beneficial for UE in power saving perspective.

### 3) Option 3: No Default Availability Indication Signaling is Defined

In some embodiments of the present disclosure, no default signaling is defined for TRS/CSI-RS availability indication. In other words, both SIB based signaling and L1 based signaling can be enable/disable according to a specific use case scenario as explained in section 1. The enabling and disabling of SIB based signaling or L1 based signaling can be performed by a NewBitField configured in the same SIB_X which is used to configure the same TRS/CSI-RS resources. The example of including NewBitField in the SIB_X is shown in the following IE.

| .... | | |
|---|---|---|
| NewBitField | BIT STRING (SIZE (1))... | OPTIONAL |

....

The size of NewBitField is just one bit which can perform enabling and disabling of both SIB based and L1 bases signaling. In this disclosure it is proposed that the presence of NewBitField can be considered as enabling of L1 based signaling. Similarly, the absence of NewBitField can be considered as the enabling of SIB based signaling as shown in table 2. It is worthy to note that when L1 based signaling is enabled the SIB based signaling will be considered as disable and vice versa. Furthermore, the NewBitField value can further define to enable/disable PEI based indication or P-DCI based indication. For instance, when the NewBitField value is “1” PEI based availability indication of TRS/CSI-RS is enabled and when the NewBitField value is “0” P-DCI based availability indication of TRS/CSI-RS is enabled as shown in table 3.

TABLE 2

| gNB action/UE assumption | SIB_X NewBitField |
|---|---|
| Enable L1 based Indication | Field is present |
| Enable SIB based indication | Field is absent |

TABLE 3

| gNB action/UE assumption | SIB_X NewBitField |
|---|---|
| Enable PEI based Indication | 1 |
| Enable P-DCI based Indication | 0 |

### 4 TRS/CSI-RS Availability Indication Overhead Reduction

In order to reduce the TRS/CSI-RS availability indication overhead and extend the use case scenarios of SIB based signaling and L1 based signaling for TRS/CSI-RS availability indication, some embodiments of the present disclosure consider the following two options.

Option 1: To indicate the TRS/CSI-RS availability indication per cell based. In other words, gNB can transmit only one indication to inform the availability of TRS/CSI-RS to all the idle/inactive UEs which are camped under the same serving cell. In this option, since all the idle/inactive UE are camped under the same serving cell, gNB can use L1 based signaling such as PEI or P-DCI based indication to inform the TRS/CSI-RS availability to the idle/inactive UEs.

Option 2: To indicate the TRS/CSI-RS availability per paging group based for the next PO. In other words, gNB can transmit only one indication to inform the TRS/CSI-RS availability to all the UEs in a group which needs paging. In this option, some of the idle/inactive UE inside a paging group maybe camped to a different serving cell or some of the idle/inactive UE in a paging group maybe moving to a new cell. In this case L1 based indication received from the original cell becomes invalid. Therefore, to indicate the TRS/CSI-RS availability per paging group based to the idle/inactive UEs, SIB based signaling shall be considered.

The embodiments of the present disclosure simultaneously configure both SIB based signaling and L1 based signaling for availability indication of TRS/CSI-RS occasion to the idle/inactive UE and discuss enabling/disabling procedure of SIB based and L1 based signaling in order to use only one signaling type which is suitable to a specific use case scenario. The proposed solutions are summarized as below.
Several use case scenarios of SIB based and L1 based signaling for availability indication of TRS/CSI-RS occasion to the idle/inactive UEs has been proposed.
Several options of simultaneous configuration of SIB based and L1 based signaling for TRS availability indication has been proposed.
Numerous options of enabling/disabling of SIB based signaling and L1 based signaling has been proposed.
L1 based indication such as PEI based indication and P-DCI based indication use case scenarios has been proposed.
Per-group based and per-cell based availability indication has been proposed in order to reduce indication overhead.

The embodiments of the present disclosure consider both SIB based signaling and L1 based signalling to inform the availability of TRS/CSI-RS occasion to the idle/inactive UE and have the following advantages:
1. Defines use cases to cover all scenarios which are appropriate for either SIB based signaling or L1 based signaling.
2. Enriches network/gNB with a toolbox of TRS/CSI-RS availability indication signaling by simultaneous configuration of both SIB/L1 based signaling and allow network/gNB to have the flexibility of selecting an appropriate signaling type for a specific use case scenario.
3. Considers enabling/disabling of SIB based signaling and L1 based signaling, in order to use only one appropriate signaling type at a time.
4. Allow UE to use a signaling type according to a specific use case in order to enhance power saving.
5. Considers TRS/CSI-RS availability indication based on per cell and per group in order to reduce the availability indication overhead.

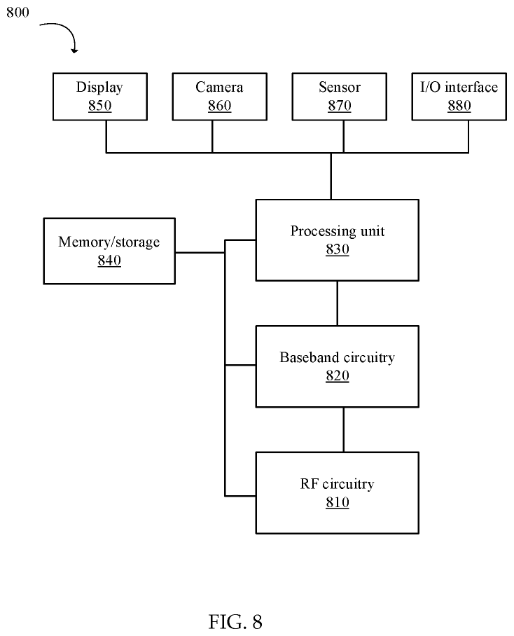

FIG. 8 is a block diagram of an example system 800 for wireless communication according to an embodiment of the present disclosure. Embodiments described herein may be implemented into the system using any suitably configured hardware and/or software. FIG. 8 illustrates the system 800 including a radio frequency (RF) circuitry 810, a baseband circuitry 820, a processing unit 830, a memory/storage 840, a display 850, a camera 860, a sensor 870, and an input/output (I/O) interface 880, coupled with each other as illustrated.

The processing unit 830 may include a circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 820 may include a circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 820 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 810 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 810 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the UE, eNB, gNB or TRP may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 840 may be used to load and store data and/or instructions, for example, for system. The memory/storage for one embodiment may include any combination of suitable volatile memory, such as dynamic random access memory (DRAM)), and/or non-volatile memory, such as flash memory. In various embodiments, the I/O interface 880 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 870 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 850 may include a display, such as a liquid crystal display and a touch screen display. In various embodiments, the system 800 may be a mobile computing device such as, but not limited to, a laptop computing device, a tablet computing device, a netbook, an ultrabook, a smartphone, etc. In various embodiments, system may have more or less components, and/or different architectures. Where appropriate, methods described herein may be implemented as a computer program. The computer program may be stored on a storage medium, such as a non-transitory storage medium.

The embodiment of the present disclosure is a combination of techniques/processes that can be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A user equipment (UE), comprising a processor, configured to call and run program instructions stored in a memory, to execute:
receiving an indication of availability of Tracking Reference Signal (TRS) occasion in an idle/inactive state from a base station (BS) through System Information Block (SIB) based signaling in at least one of the following:
(a) whenever the UE does not have a valid version of a stored SIB which is used to configure TRS resource;
(b) upon cell selection or cell-reselection performed by the UE; and
(c) when the UE returns from out of coverage.

2. The UE according to claim 1, wherein the indication of availability of TRS occasion is associated to presence or absence of a same SIB_X which is used to configure the TRS resource.

3. The UE according to claim 1, wherein the indication of availability of TRS occasion is configured by a bit carried by SIB_X which is used to configure the same TRS resource.

4. The UE according to claim 1, wherein the indication of availability of TRS occasion is per paging group based.

5. A user equipment (UE), comprising a processor, configured to call and run program instructions stored in a memory, to execute:
receiving an indication of availability of Tracking Reference Signal (TRS) occasion in an idle/inactive state from a base station (BS) through Layer 1 (L1) based signaling in at least one of the following:
(a) whenever the UE is camped on a same serving cell for at least two paging occasions (POs); and
(b) upon receiving an indication that system information has changed but the UE still remains camped on the same serving cell.

6. The UE according to claim 5, wherein the indication of availability of TRS occasion is carried by paging Early Indication (PEI) when the UE is paging in non-consecutive way in successive PO of a paging frame.

7. The UE according to claim 5, wherein the indication of availability of TRS occasion is carried by paging Downlink Control Information (DCI) when the UE is paging in consecutive way in successive PO of a paging frame.

8. The UE according to claim 5, wherein the indication of availability of TRS occasion is per cell based.

9-22. (canceled)

23. A base station (BS), comprising a processor, configured to call and run program instructions stored in a memory, to execute:
transmitting to a user equipment (UE) an indication of availability of Tracking Reference Signal (TRS) occasion in an idle/inactive state of the UE through System Information Block (SIB) based signaling in at least one of the following:
(a) whenever the UE does not have a valid version of a stored SIB which is used to configure TRS resource;
(b) upon cell selection or cell-reselection performed by the UE; and
(c) when the UE returns from out of coverage.

24. The BS according to claim 23, wherein the indication of availability of TRS occasion is associated to presence or absence of a same SIB_X which is used to configure the TRS resource.

25. The BS according to claim 23, wherein the indication of availability of TRS occasion is configured by a bit carried by SIB_X which is used to configure the same TRS resource.

26. The BS according to claim 23, wherein the indication of availability of TRS occasion is per paging group based.

27-42. (canceled)
